(19) United States
(12) Patent Application Publication
(10) Pub. No.: US 2019/0072719 A1
(43) Pub. Date: Mar. 7, 2019

(54) WAVEGUIDE TERMINATION MODULE AND METHOD OF TERMINATION

(71) Applicant: Molex, LLC, Lisle, IL (US)

(72) Inventors: Malcolm H. HODGE, Chicago, IL (US); Calob LOSTUTTER, Bolingbrook, IL (US)

(73) Assignee: Molex, LLC, Lisle, IL (US)

(21) Appl. No.: 16/079,827

(22) PCT Filed: Feb. 24, 2017
(86) PCT No.: PCT/US2017/019310

§ 371 Date: Aug. 24, 2018

Related U.S. Application Data
(60) Provisional application No. 62/299,805, filed on Feb. 25, 2016.

(51) Int. Cl. G02B 6/24; G02B 6/125; G02B 6/38

(52) U.S. Cl. CPC G02B 6/241; G02B 6/125; G02B 6/3881; G02B 6/3839; G02B 6/3861

(57) ABSTRACT

Optical waveguide termination module assemblies include a plurality of optical fibers with each having a retained first portion and a movable second portion. The movable second portions are configured to be mounted on an optical waveguide member. Optical assemblies and methods of forming the optical assemblies with the optical waveguide termination module assemblies are also disclosed.

### RELATED APPLICATIONS

This patent application claims priority to U.S. Provisional Patent Application 62/299,805, entitled “WAVEGUIDE TERMINATION MODULE AND METHOD OF TERMINATION,” which was filed on Feb. 25, 2016, and which is incorporated here by reference.

### TECHNICAL FIELD

This disclosure relates generally to optical interconnections and, more particularly, to a module for and a method of terminating a plurality of optical waveguides.

### BACKGROUND

Optical circuits are used to interconnect optical components within electronic and other high speed and/or high bandwidth systems. In some applications, optical circuits are formed on a planar substrate with a plurality of optical waveguides surrounded on at least one side by a cladding material. The waveguides and cladding may be formed in a plurality of layers as desired. The substrate may be formed of any desired material and, in some instances, may be flexible. The waveguides and cladding may be formed of any material having the desired optical characteristics. In some instances, the waveguides and cladding may be formed of a resin or polymer material.

Interconnections between planar optical circuit members and optical fibers have proven to be relatively complex and time consuming. The cores of the optical fibers must be precisely aligned with each waveguide of the circuit member in order to create an optically efficient connection. The optical fibers typically have a diameter of 125 μm and their cores have a diameter of approximately 50 μm. One type of planar optical circuit member has a plurality of waveguides with alignment rails positioned in a parallel manner adjacent a termination location for each waveguide. A simple and cost effective manner of interconnecting optical fibers to the waveguides of a planar optical circuit member would be useful.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In one aspect, an optical waveguide termination module assembly includes a waveguide termination module having an engagement surface for engaging one of an optical waveguide member and a surface of at least one optical fiber, and at least one optical fiber secured to the waveguide termination module. Each optical fiber has a first portion with an angled segment being at an angle to the engagement surface and a second portion having a free end generally adjacent the engagement surface and being movable relative to the waveguide termination module prior to mounting the optical waveguide termination module assembly on the optical waveguide member.

In another aspect, an optical assembly includes an optical waveguide member having at least one waveguide with a waveguide free end, and an alignment channel generally parallel to and aligned with each waveguide, a waveguide termination module, and at least one optical fiber secured to the waveguide termination module. Each optical fiber has a first portion including an angled segment and a second portion including a fiber free end aligned with the waveguide free end of one of the at least one waveguide. An alignment segment of the second portion is positioned within the alignment channel aligned with the one of at least one waveguide and the alignment segment of the second portion is at an angle to the angled segment of the first portion.

In still another aspect, an optical waveguide termination module assembly includes at least one optical fiber having a first portion and a second portion which has a free end. A waveguide termination module has a first section with the first portion of each optical fiber secured thereto, an alignment section with the second portion of each optical fiber extending in a cantilevered manner therealong and away from the first face, and a waveguide support section having an opening therein configured to receive a portion of an optical waveguide member therein and extending to the alignment section.

In a further aspect, an optical assembly includes an optical waveguide member with at least one waveguide having a waveguide free end, and an alignment channel generally parallel to and aligned with each waveguide. At least one optical fiber has a first portion and a second portion. The second portion has a fiber free end aligned with the waveguide free end of one of the waveguides and an alignment segment of the second portion positioned within one of the alignment channels. A waveguide termination module has a first section with the first portion of each optical fiber secured thereto, an alignment section with the second portion of each optical fiber secured within an alignment channel of the optical waveguide member along the alignment section, and a waveguide support section supporting a portion of the optical waveguide member.

### BRIEF DESCRIPTION OF THE DRAWINGS

FIG. 1 is a perspective view of an optical waveguide termination module assembly;

FIG. 2 is a sectional view taken generally along line 2-2;

FIG. 3 is a perspective view of the waveguide termination module of FIG. 1 from an opposite direction and from below the module;

FIG. 4 is an end view of the optical waveguide termination module assembly of FIG. 1 mounted on an optical waveguide member;

FIG. 5 is an end view similar to that of FIG. 4 with a second embodiment of the waveguide termination module;

FIG. 6 is an end view similar to that of FIG. 4 with a third embodiment of the waveguide termination module;

FIG. 7 is a sectional view similar to that of FIG. 2 but of a fourth embodiment of the waveguide termination module;

FIG. 8 is a perspective view of a portion of an optical waveguide member;

FIG. 9 is a sectional view similar to that of FIG. 2 with the optical waveguide termination module assembly positioned above and aligned with the optical waveguide member;

FIG. 10 is a sectional view similar to that of FIG. 9 with the optical waveguide termination module assembly moved closer to the optical waveguide member;

FIG. 11 is a sectional view similar to that of FIG. 10 with the optical waveguide termination module assembly engaging the optical waveguide member;

FIG. 12 is a sectional view similar to that of FIG. 11 with the optical fiber of the optical waveguide termination module assembly adjacent the waveguide of the optical waveguide member;

FIG. 13 is a perspective view similar to that of FIG. 8 but with portions of optical fibers mounted thereon;

FIG. 14 is a sectional view of a fifth embodiment of an optical waveguide termination module assembly;

FIG. 15 is a sectional view similar to that of FIG. 14 but with an optical waveguide member partially inserted into the optical waveguide termination module assembly;

FIG. 16 is a sectional view similar to that of FIG. 15 but with the optical waveguide member moved vertically downward relative to the optical waveguide termination module assembly;

FIG. 17 is a sectional view similar to that of FIG. 16 but with the optical waveguide member fully inserted into the optical waveguide termination module assembly;

FIG. 18 is a sectional view of a sixth embodiment of an optical waveguide termination module assembly;

FIG. 19 is an end view of the mating face of the optical waveguide termination module assembly of FIG. 18; and

FIG. 20 is a sectional view of the optical waveguide termination module assembly of FIG. 18 mounted on an optical waveguide member.

### DETAILED DESCRIPTION

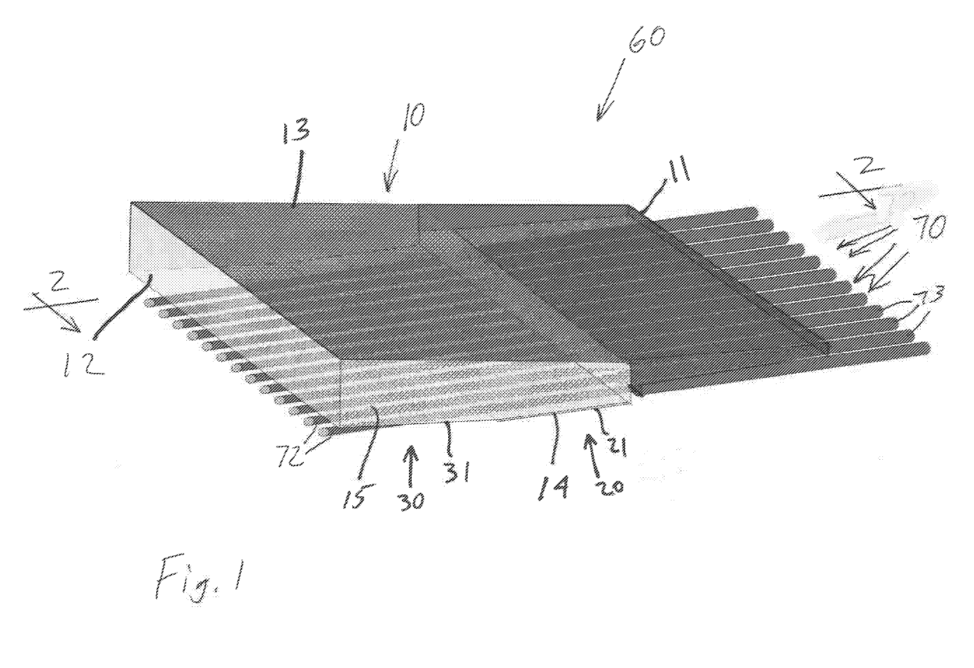

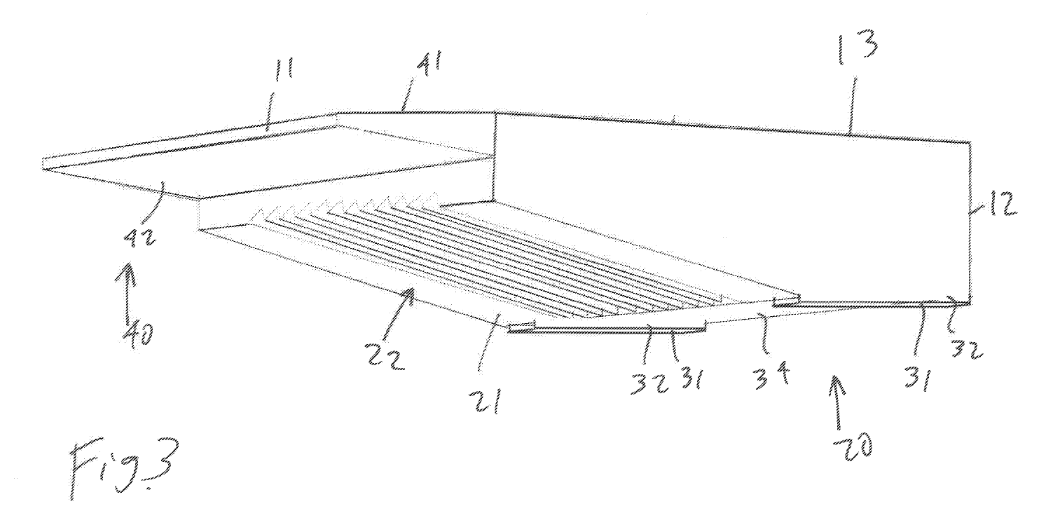

Referring to FIGS. 1-3, a plurality of optical fibers 70 are mounted on a waveguide termination module 10 to create an optical waveguide termination module assembly 60. Each optical fiber 70 has a core 71 (FIG. 4) that is surrounded by a concentric cladding 72 and a concentric buffer 73 that protects and surrounds the cladding 72. The waveguide termination module 10 includes a body having a rear or optical fiber end 11, an opposite front or termination end 12, an upper surface 13, and a lower surface 14. The upper surface 13 and the lower surface 14 extend between the rear end 11 and the connection end 12.

The waveguide termination module 10 includes a fiber orientation and securement section 20 and a fiber termination section 30 that extends from the fiber orientation and securement section 20 towards the termination end 12. If desired, a support section 40 may extend rearwardly from the fiber orientation and securement section 20.

The fiber orientation and securement section 20 is operative to orient and secure the plurality of optical fibers 70 to the waveguide termination module 10 in their desired orientation prior to mounting the termination module on an optical waveguide member 200. The lower surface 21 of the fiber orientation and securement section 20 may be at an angle 50 to the mounting surface 31 of fiber termination section 30 as best seen in FIG. 3. The angle 50 may be any desired angle. As described in further detail below, the angle 50 operates to assist in positioning a portion of each optical fiber 70 within an alignment channel 212 of the optical waveguide member 200 (FIG. 8) and in a desired alignment. In addition, in some embodiments, the angle 50 may also operate to create a space for the buffer 73 of the optical fibers 70 or to position an end or portion of the waveguide termination module spaced from the fiber termination section 30 at a desired position or orientation. In one example, the angle 50 may be approximately 8 degrees. In another example, the angle 50 may be between approximately 0.5 and 15 degrees. In still another example, the angle 50 may be between approximately 0.5 and 30 degrees.

The lower surface 21 of the fiber orientation and securement or retention section 20 includes a plurality of parallel alignment members or grooves such as V-grooves 22 that extend along a length of the lower surface in a front to rear direction along the securement section. The V-grooves 22 are dimensioned to receive and accurately secure therein portions of the plurality of optical fibers 70 that have the cladding 72 exposed. In other words, the buffer 73 has been removed from the portions of the optical fibers 70 that are secured within the V-grooves 22. It is not necessary for the V-grooves 22 to extend the entire length of the fiber orientation and securement section 20. The optical fibers 70 may be secured within the V-grooves 22 with an adhesive such as epoxy.

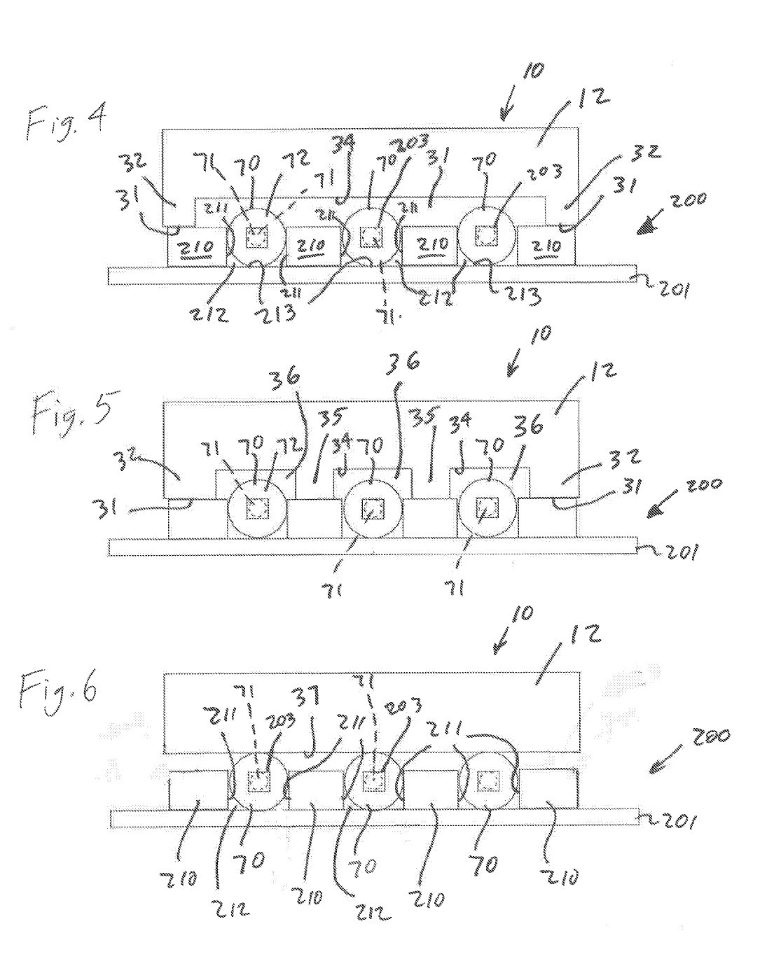

As described in further detail below, the fiber termination section 30 is operative to protect portions of the optical fibers 70 prior to mounting the waveguide termination module 10 on the optical waveguide member 200 (FIG. 8), to secure the termination module on the optical waveguide member, and may perform additional functions such as assisting in positioning portions of the optical fibers on the optical waveguide member (FIG. 6). In one embodiment depicted in FIG. 4, the mounting surface 31 of the fiber termination section 30 may be defined by a mounting support member 32 generally adjacent sidewall 15 of the waveguide termination module 10 that engages a portion of the optical waveguide member 200. A recess 33 may be located between the mounting surface 31 and a lower face 34 of the fiber termination section 30 aligned with the optical fibers 70. The depth of the recess 33 may be sufficient so that optical fibers 70 may be mounted on the optical waveguide member 200 without the optical fibers contacting the lower face 34. The depth of the recess 33 may thus be dependent upon dimensions of the optical waveguide member 200.

In another embodiment depicted in FIG. 5, additional mounting support members 35 may be provided that extend downward from the lower face 34 between the mounting support members 32. Adjacent pairs of the additional mounting support members 35 may define channels 36 within which an optical fiber 70 may be positioned. The upper surfaces of the channels 36 form portions of lower face 34.

Referring to FIG. 6, in still another embodiment, the lower face 37 may contact the upper surfaces of the optical fibers 70. In such an embodiment, the lower face 37 operates to force or push the optical fibers 70 into their desired positions on the optical waveguide member 200. With such a configuration, the mounting surface 31 of the mounting support members 32 may be spaced above the optical waveguide member 200 or the mounting support members eliminated.

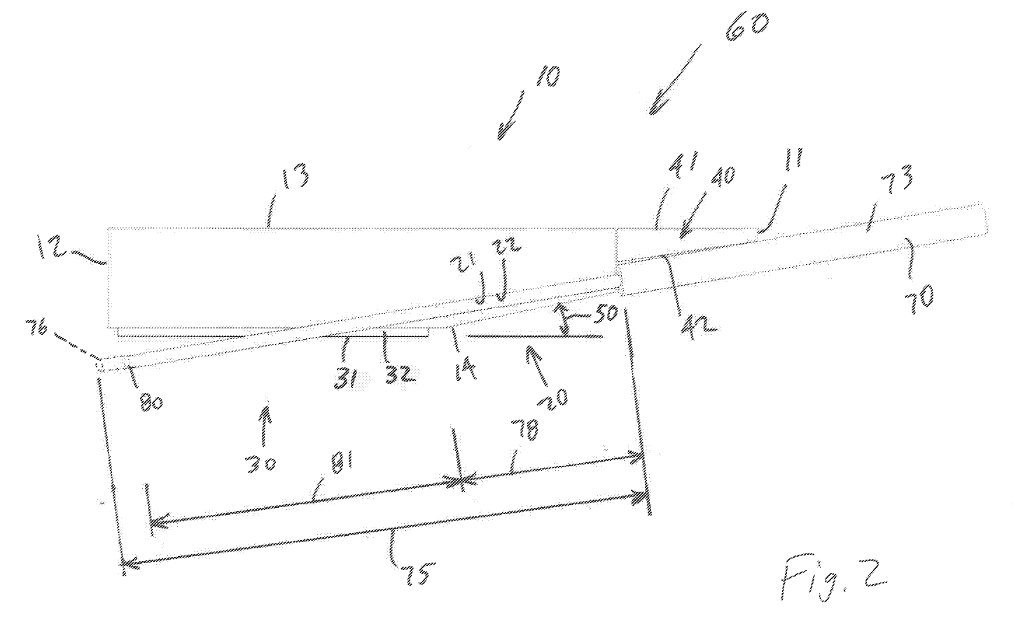

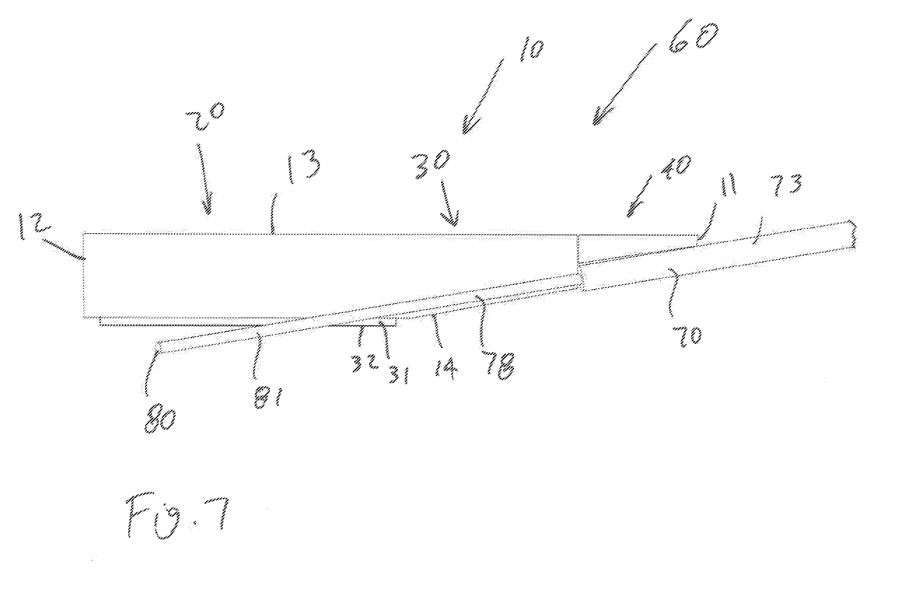

In one embodiment, the termination end 12 of the waveguide termination module 10, and thus the fiber termination section 30, may extend to a location generally aligned with the free ends 80 of the optical fibers 70 as depicted in FIGS. 1-2. In another embodiment depicted in FIG. 7, the termination end 12 of the waveguide termination module 10 may extend past the free ends 80 of the optical fibers 70 and thus may overlap, to a significant extent, waveguides 203 of the optical waveguide member 200.

Referring back to FIGS. 2-3, the support section 40 may be included to provide additional support to the plurality of optical fibers 70 that extend from the fiber orientation and securement section 20. The support section 40 may operate as an area in which a plurality of individual optical fibers 70 are secured together. The support section 40 may include an upper surface 41 that may be an extension and/or coplanar with the upper surface of the fiber orientation and securement section 20. The lower face 42 of the support section 40 may extend generally at the same angle as the lower surface 21 of the fiber orientation and securement section 20 but is offset from the lower surface 21 to accommodate the larger diameter of the buffer 73 of the optical fibers 70. The optical fibers 70 may be secured along lower face 42 with an adhesive such as epoxy.

The waveguide termination module 10 may be formed of any desired material. In one example, the waveguide termination module 10 may be formed of a material such as a moldable resin or polymer with an appropriate additive so that the module has a coefficient of expansion similar to that of the optical fibers 70. In another example, the waveguide termination module 10 may be formed of a material such as a moldable resin or polymer so that the module has a coefficient of expansion similar to that of the optical waveguide member 200. If desired, the waveguide termination module 10 may be transparent to ultraviolet light to permit the use of ultraviolet curable adhesives such as an epoxy.

To mount optical fibers 70 on waveguide termination module 10 to create an optical waveguide termination module assembly 60, the optical fibers 70 are prepared by stripping or removing the buffer 73 and any other material surrounding the cladding 72 from a predetermined length 75 (FIG. 2) of each optical fiber. The stripped length 75 extends between the initial end 76 of each optical fiber and the edge 77 of the buffer 73. An adhesive is applied to the V-grooves 22 and a first portion 78 of the predetermined length 75 inserted into the V-grooves. The adhesive is cured to secure the first portion 78 within the V-grooves 22. If desired, a length of the buffer 73 beginning near the edge 77 may be secured to the lower face 42 of the support section 40 such as with an adhesive.

The optical fibers 70 are cut or cleaved at a desired location along the stripped length 75 to create a free end 80 spaced from the first portion 78. As a result, each optical fiber 70 includes a cantilevered second portion 81 that extends from the free end 80 to the first portion 78 and which does not engage the fiber termination section 30. More specifically, since the V-grooves 22 extend at an angle 50 to the lower face 34 of the fiber termination section 30, the second portions 81 of the optical fibers 70 project or extend below the lower face 34 and the entire waveguide termination module 10, and thus are movable relative to the lower face 34.

Referring to FIG. 8, the optical fiber termination module assemblies 60 are configured to be mounted on an optical waveguide member 200. The optical waveguide member 200 includes a base material or substrate 201. A cladding layer 202 may be applied to the substrate 201 and a plurality of optical waveguides 203 formed on the cladding layer. The index of refraction of the waveguides 203 is higher than that of the cladding layer 202. The substrate 201, the cladding layer 202, and the waveguides 203 may be formed of any desired materials and in any desired manner. It should be noted that cladding layer 202 is omitted from below the waveguide 203 in FIGS. 4-6 and 13 for clarity. Further, while the number of waveguides 203 on optical waveguide member 200 will match the optical fibers 70 on the optical waveguide termination module assembly 60, the number of waveguides depicted in FIG. 8 is reduced for clarity.

The substrate 201 may include a plurality of waveguides 203 that have their ends 204 aligned at a termination location 205 to facilitate an interconnection to other devices and components. The termination locations 205 may be located near the edges 217 (FIG. 15) of the optical waveguide member 200 and/or spaced from the edges of the optical waveguide member.

A plurality of alignment members configured as alignment rails 210 may be formed adjacent the termination locations 205. The alignment rails 210 are positioned parallel to the waveguides 203 and are spaced apart so that the sidewalls 211 of adjacent rails define an alignment channel 212 that is aligned with each waveguide. The alignment channels 212 are dimensioned to be slightly larger than the diameter of the cladding 71 of optical fiber 70 so that a length or segment of the second portion 81 of the stripped length 75 of the optical fiber may be received therein with the core 71 of the optical fiber 70 laterally aligned with the waveguide 203. The lower surface 213 of the channel 212 is dimensioned so that core of the optical fiber 70 is vertically aligned with the waveguide 203. In some embodiments, the upper surface 214 of the alignment rails 210 may interact with the mounting surface 31 of the fiber termination section 30 to locate the waveguide termination module 10 at a desired height relative to the waveguides 203 and the channel 212. In other embodiments, the mounting surface 31 of the fiber termination section 30 may interact with the substrate 201 rather than the alignment rails 210.

The alignment rails may be formed of any desired materials and in any desired manner. In the embodiment depicted in FIG. 8, the alignment rails 210 are formed from a plurality of layers of material. A first layer 215 is formed from the cladding layer 202 upon which the waveguides 203 are positioned. The second layer 216 is formed from the material used for the waveguides 203. Without regard to their optical characteristics, the first layer 215 and the second layer 216 combine to form the mechanical alignment members used to laterally align the optical fibers 70 relative to waveguides 203.

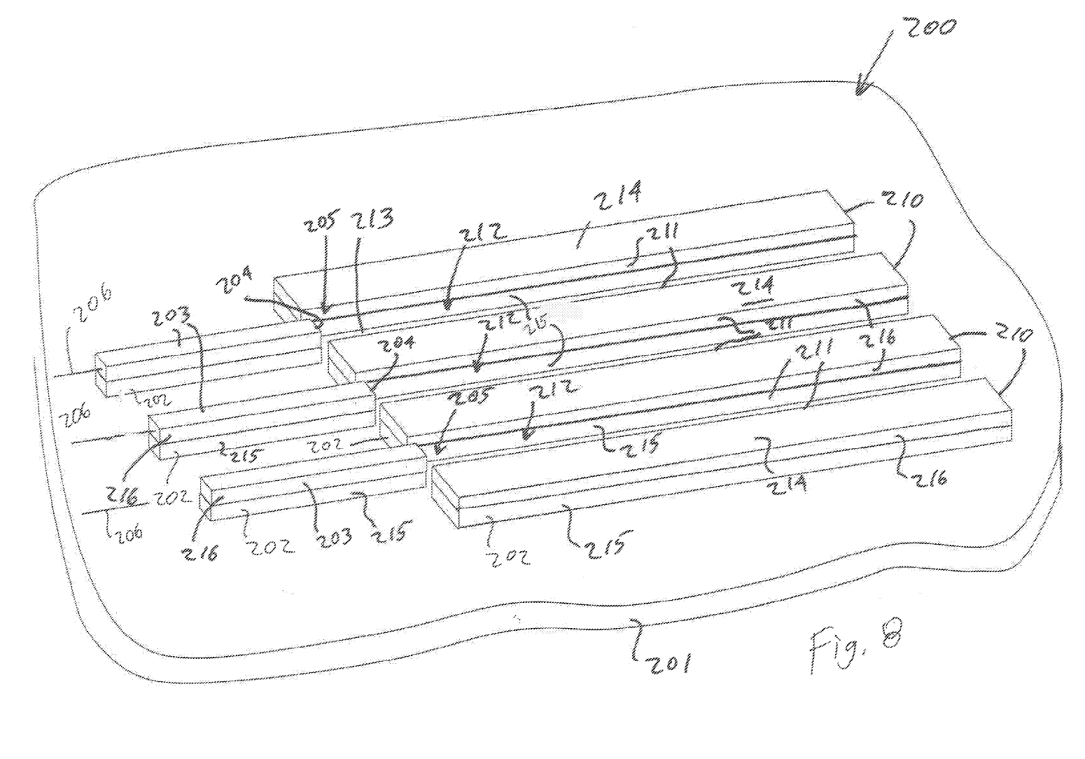

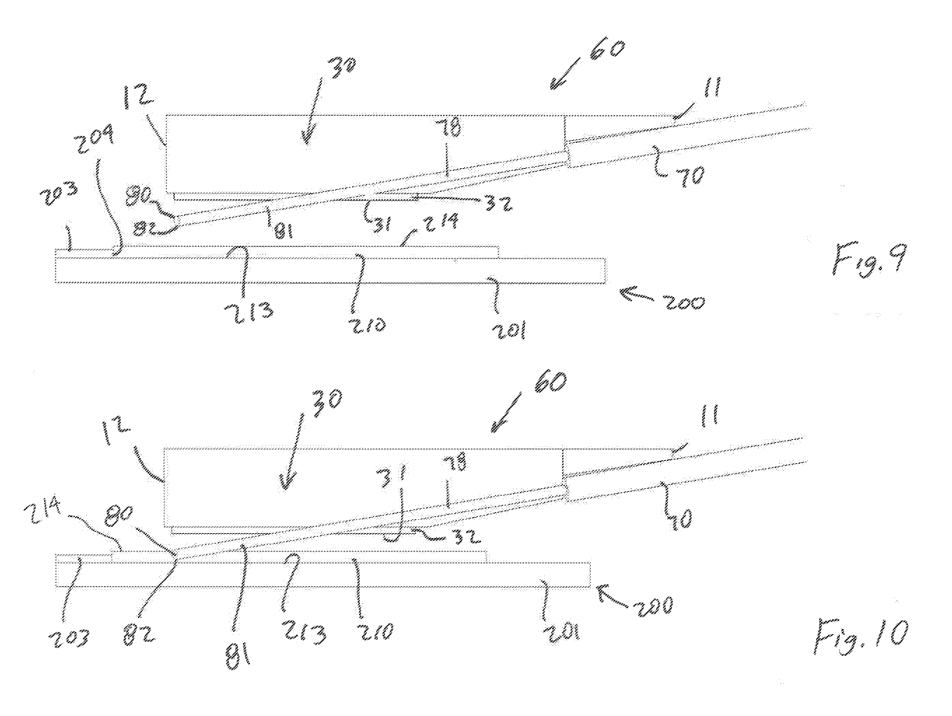

To mount an optical waveguide termination module assembly 60 on the optical waveguide member 200, an adhesive may be applied at the ends 204 of the waveguides 203 and within the channels 212 between the alignment rails 210. The adhesive may be any desired material sufficient to maintain a desired level of optical performance. In one example, the adhesive may be an optical index-matched ultraviolet curable epoxy. The optical waveguide termination module assembly 60 is positioned above the alignment rails 210 with an optical fiber 70 aligned so as to be parallel to each channel 212 as depicted in FIG. 9. The second portion 81 of each optical fiber 70 is spaced from the optical waveguide member 200.

Since the V-grooves 22 along the lower surface 21 of the fiber orientation and securement section 20 are at an angle 50 to the mounting surface 31 of the fiber termination section 30, the free ends 80 and at least a length or segment of the second portions 81 of optical fibers 70 extend below the mounting surface. The second portions 81 may be short enough to remain generally co-linear with the first portions 78 prior to mounting the termination module assembly 60 on waveguide member 200 but long enough so that the second portions may be bent upon mounting the termination module assembly 60 without materially reducing the optical characteristics of the optical fibers 70. In one example, it is desirable for a curve or bend in the optical fiber 70 to have a radius of greater than approximately 0.25 inches. In another example, it is desirable for a curve or bend in the optical fiber 70 to have a radius of greater than approximately 1.0 inches

Upon lowering the optical waveguide termination module assembly 60 relative to the optical waveguide member 200, the lower edge 82 of the free ends 80 of the optical fibers 70 will engage the lower surface 213 of the channels 212 as depicted in FIG. 10. Continued movement of the optical waveguide termination module assembly 60 towards the optical waveguide member 200, will cause the deflection of the second portions 81 of the optical fibers 70 until the mounting surface 31 of the fiber termination section 30 engages the upper surface 214 of the alignment rails 210 and stops the vertical movement of the optical waveguide termination module assembly 60 relative to the optical waveguide member 200 as depicted in FIG. 11. In some instances, other structures of the optical waveguide termination module assembly 60 and the optical waveguide member 200 may interact to stop the vertical movement of the components and position the second portions 81 of the optical fibers 70 at the desired location relative to the waveguide member.

Once the mounting surface 31 of the fiber termination section 30 engages the upper surface 214 of the alignment rails 210, the free end 80 and a first segment 85 of the second portion 81 of each optical fiber 70 is aligned along the waveguide axis 206 (FIG. 11) or co-linear with each waveguide 203 but spaced from the end 204 at the termination location 205. A second segment 86 of the second portion 81 extends between and optically connects the first segment 85 to the first portion 78. The angle 50 between the V-grooves 22 of the fiber orientation and securement section 20 and the mounting surface 31 of the fiber termination section 30 results in the second segment 86 of the second portion 81 being curved or bent. As stated above, in some applications, it may be desirable to avoid a curve or bend in the optical fiber 70 that has a radius of less than approximately 0.25 inches to avoid a material reduction in the optical characteristics of the optical fibers 70. In other applications, it may be desirable to avoid a radius that is less than 1.0 inch.

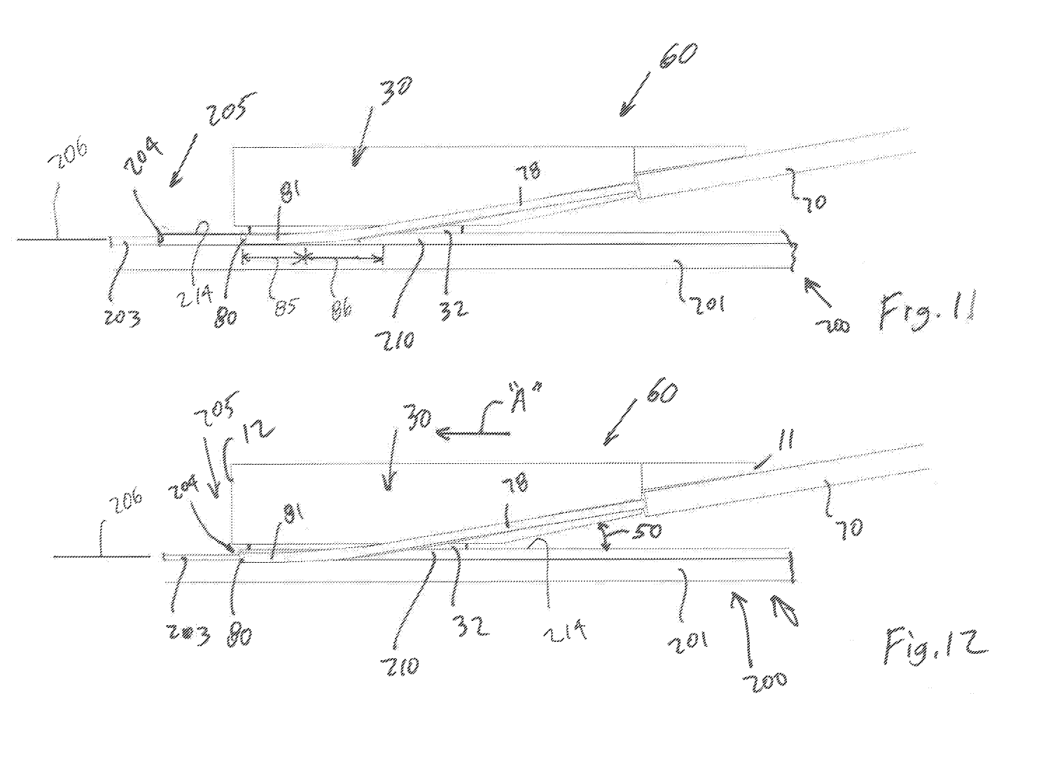

The optical waveguide termination module assembly 60 is then slid towards the ends 204 of the waveguides 20′3 in the direction of arrow “A” until the free ends 80 of the second portions 81 of the optical fibers are positioned at the desired location relative to the ends of the waveguides as depicted in FIGS. 12 and 13. The optical waveguide termination module assembly 60 is secured in place such as by applying ultraviolet light to cure the adhesive located along the optical waveguide member 200 to secure the various components including the free ends 80 of the optical fibers 70 adjacent the ends 204 of the waveguides 203, the second portions 81 of the fibers within the channels 212, and the fiber termination section 30 to the rails 210.

From the foregoing, it may be understood that the angle 50 between the mounting surface 31 (or the upper surface 214 of rails 210) and the lower surface 21 of fiber orientation and securement section 20 (or the first portion 78 of optical fibers 70) may operate to perform two different but somewhat related functions. The angle 50 operates to assist in positioning a portion of each optical fiber 70 within a channel 212 of the optical waveguide member 200 and in a desired alignment. The optical fibers 70 are relatively stiff (for their size) and the angle 50 allows the elasticity of the fibers to bias the lower surface of the optical fibers towards and into contact with the lower surface 213 of the channels 212 between rails 210 of the optical waveguide member 200 as depicted in FIG. 13 which results in a segment of the optical fiber 70 being positioned along the waveguide axis 206. The length of the segment of the optical fiber 70 that is positioned along the waveguide axis 206 may be based upon a desired minimum bend radius of the optical fiber and the desired minimum bend radius may be dependent upon optical, mechanical, and/or other performance limits.

The angle 50 may also operate to create a space that allows the buffer 73 to rise above the optical waveguide member 200 as the optical fibers 70 extend away from the termination location 205. This may be particularly useful when the termination locations 205 of the optical waveguide member 200 are remote or spaced from the edge 217 of the optical waveguide member. More specifically, referring to FIG. 12, the angle 50 between the mounting surface 31 (or the upper surface 214 of rails 210) and the first portion 78 of optical fibers 70 causes an increase in the distance or clearance between the optical waveguide member 200 as the length of the waveguide termination module 10 increases. Thus, the increase in clearance is dependent upon the length of the angled lower surface 21 of the fiber orientation and securement section 20 and the angle 50.

The clearance or distance between the optical fibers 70 and optical waveguide member 200 creates a space for the increased diameter of the optical fibers 70 at the buffer 73. Further, for termination locations 205 that are not adjacent the edge 217 of the optical waveguide member 200, a minimum angle 50 may be required or desired to provide a clearance for the buffer 73. In other applications, it may be desirable to increase the angle 50 so that the optical fibers 70 extend above the optical waveguide member 200 relatively quickly and do not block access or otherwise occupy space on the optical waveguide member.

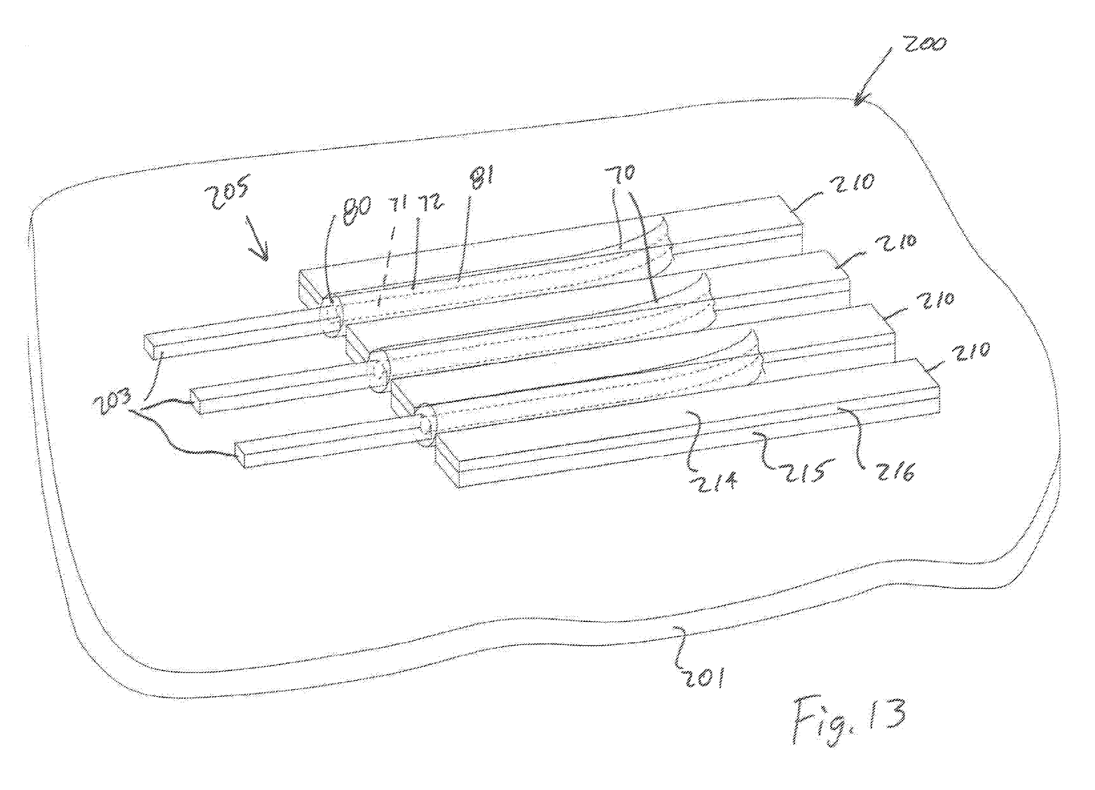

In an additional embodiment depicted in FIG. 14, an optical waveguide termination module assembly 160 is operative to interconnect a plurality of waveguides 203 at an edge 217 of an optical waveguide member 200 to an optical fiber interconnection module such as a ferrule. Such a configuration will permit an interconnection of the optical waveguide member 200 with other assemblies and devices that are terminated with a ferrule or another module. The optical waveguide termination module assembly 160 includes a waveguide termination module 110 with a plurality of optical fibers 170 mounted thereon. Each optical fiber 170 has a core that is surrounded by a concentric cladding 172 and may be prepared by removing a concentric buffer and any other material that surrounds the cladding. The refractive index of the cladding 172 is lower than the refractive index of the core.

The waveguide termination module 110 may be configured from a ferrule with a mating end or face 111, an opposite connection end 112, an upper surface 113, and a lower surface 114. The waveguide termination module 110 includes a fiber orientation and securement section 120 that extends from the mating face 111 towards the connection end 112, a fiber termination section 130 that extends from the fiber orientation and securement section 120 towards the connection end, and a waveguide support section 140 that extends rearwardly, or towards the connection end, from the fiber termination section.

The fiber orientation and securement section 120 is operative to secure or position the plurality of optical fibers 170 to the waveguide termination module 110 prior to terminating or connecting the termination module to the optical waveguide member 200. The fiber orientation and securement section 120 may include a plurality of bores 121 into which a first portion 178 of the optical fibers 170 are inserted and secured with an adhesive such as an ultraviolet curable epoxy. In other embodiments, the fiber orientation and securement section 120 may include a vertical recess (not shown) that extends from one of the upper surface 113 or lower surface 114 of the waveguide termination module 110. A plurality of V-grooves (not shown) may extend along an inner surface of the recess from the mating face 111 towards the fiber termination section 130 to facilitate mounting of the first portions 178 of the optical fibers 170 to the fiber orientation and securement section 120. The ends 104 of the optical fibers 170 and the mating face 111 of the waveguide termination module 110 may be polished, if desired.

The fiber termination section 130 is operative to protect the second portions 181 of the optical fibers 170 prior to mounting the waveguide termination module 110 and assist in positioning the second portions of the optical fibers relative to the optical waveguide member 200. The fiber termination section 130 includes a recess or reservoir 133 that extends from one or both of the upper surface 113 and the lower surface 114 of the waveguide termination module 110 to a central location at which the second portions 181 of the optical fibers 170 are positioned and extend away from the fiber orientation and securement section 120 in a cantilevered manner. The recess 133 extends laterally between the sidewalk of the waveguide termination module 110 a sufficient distance to permit the second portions 181 of the optical fibers 170 and the portion 218 of the optical waveguide member 200 to be inserted therein.

The waveguide support section 140 is operative to support biasing member 165 and the portion 218 of optical waveguide member 200 to which the waveguide termination module 110 is secured. The waveguide support section 140 includes a slot or opening 143 that extends from the connection end 112 to the recess 133 of the fiber termination section 130. The opening 143 is large enough, both vertically (between upper surface 144 and lower surface 145) and horizontally, to facilitate mounting of the biasing member 165 and insertion of the portion 218 of optical waveguide member 200.

The biasing member 165 is operative to bias the portion 218 of the optical waveguide member 200 that is inserted through the opening 143 into the desired contact with the second portions 181 of the optical fibers 170. The biasing member 165 may be configured in any manner including the cantilevered spring 166 depicted in FIG. 14. The cantilevered spring 166 includes a contacting arm 167 for contacting a lower surface 219 of the portion 218 of the optical waveguide member 200 and a mounting member or arm 168 that may be positioned adjacent the lower surface 145 of opening 143.

To mount optical fibers 70 on waveguide termination module 110 to create an optical waveguide termination module assembly 160, the optical fibers are prepared by stripping or removing the buffer 103 and any other material surrounding the cladding 102 from a predetermined length of each optical fiber. The optical fibers 70 may be cut or cleaved to the desired length in any manner. In one example, the optical fibers 70 may be inserted into the bores 121 of the fiber orientation and securement section 120 and temporarily secured together. The optical fibers 70 may be cleaved at a first location within the recess 133 to create the free ends 180 of the second portions 181. The optical fibers 170 may then be moved forwardly towards the mating face 111 and the fibers cleaved at a second location generally adjacent the mating face 111 to create mating ends 184. The optical fibers 170 are then slid rearwardly towards the connection end 112 so that the mating ends 184 of the optical fibers are generally aligned with the mating face 111 and secured within the bores 121 as depicted in FIG. 14 with an adhesive such as epoxy.

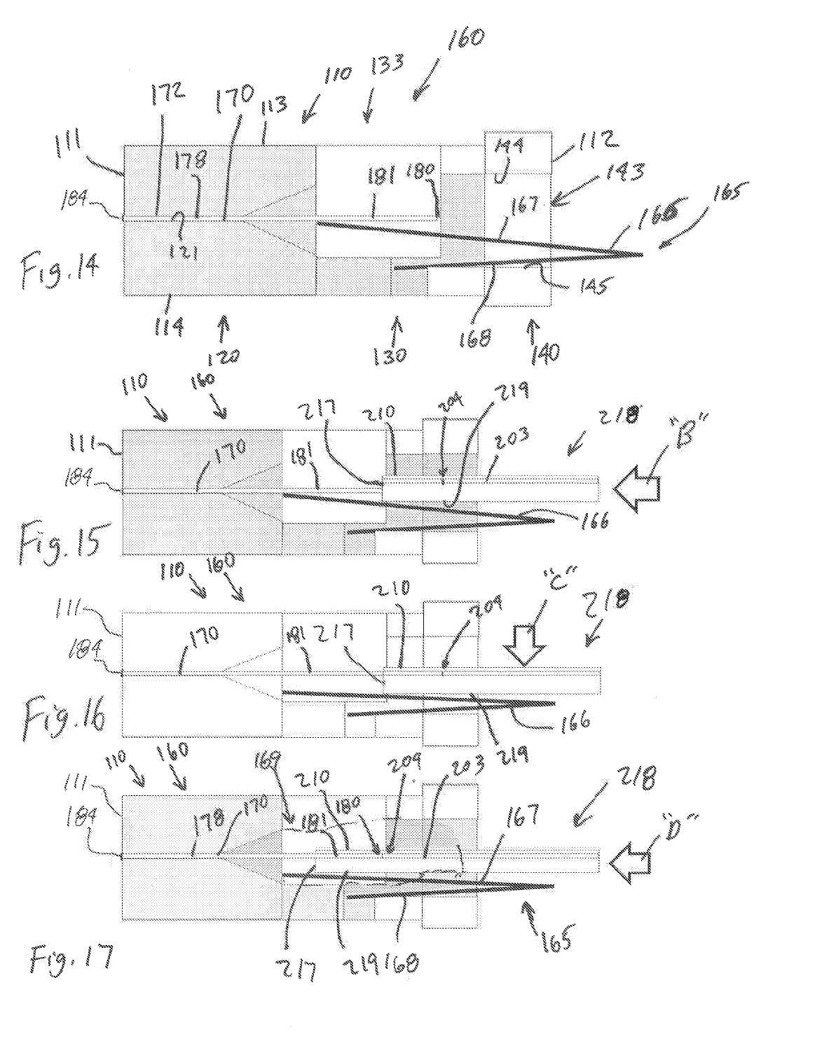

To mount an optical waveguide termination module assembly 160 on the optical waveguide member 200, a portion 218 of the optical waveguide member is aligned with the alignment rails 210 adjacent the edge 217 of the portion 218 and the ends 204 of the waveguides 203 spaced from the edge. The edge 217 of the optical waveguide member 200 is inserted into the opening 143 in the direction of arrow “B” with the optical waveguide member generally aligned with the free ends 180 of the optical fibers 170 as depicted in FIG. 15. A downward force is applied to the optical waveguide member 200 in the direction of arrow “C” in FIG. 16 so that the lower surface 219 engages the contacting arm 167 of cantilevered spring 166 to deflect the arm. Continued movement of the portion 218 of the waveguide member 200 into the opening 143 causes the edge 217 to enter the recess 133 with the waveguides 203 and the alignment rails 210 positioned below the second portions 81 of the optical fibers 70.

The downward force on the optical waveguide member 200 is reduced so that the biasing member 165 forces the portion 218 of the waveguide member 200 upwards towards the optical fibers 170 and that the second portions 181 of the optical fibers enter the channels 212. The optical waveguide member 200 is further inserted into the recess 133 as depicted in FIG. 17 by arrow “D” until the free ends 180 of the second portions 181 of the optical fibers 170 are positioned at the desired axial location relative to the ends 204 of the waveguides 203. An adhesive 169 such as an optical index-matched ultraviolet curable epoxy may be applied into the recess 133 to encapsulate the second portions 181 of the optical fibers 170, portions of the biasing member 165, and the portion 218 of the optical waveguide member 200. The adhesive is then cured to secure these components to the waveguide termination module 110.

In an alternate embodiment, the biasing member 165 does not need to be incorporated into the waveguide termination module 110. In such case, an adhesive is applied to the optical waveguide member 200 and a biasing force applied by a separate component, such as a tool or fixture (not shown), to press the optical waveguide member 200 into contact with the optical fiber 70. The optical waveguide termination module assembly 160, the optical waveguide member 200, and the tool or fixture may be retained in place while curing the adhesive. If desired, the configuration of FIG. 14 (without the biasing member 165 integral to the waveguide termination module 110) may be turned over so that gravity assists in moving or biasing the optical waveguide member 200 downward.

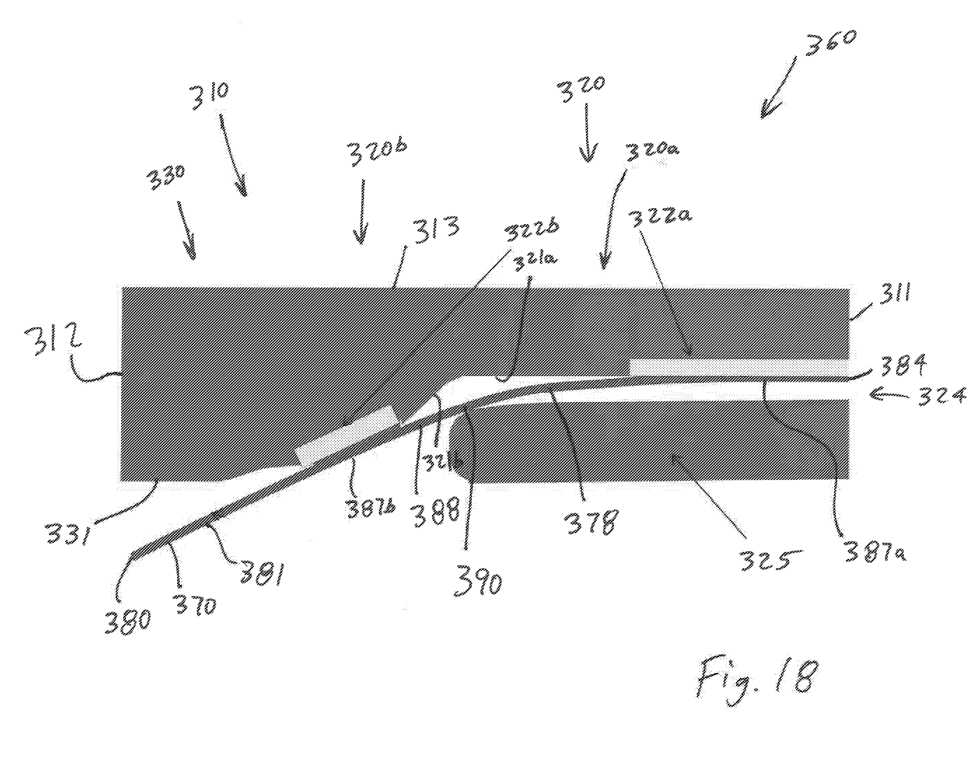

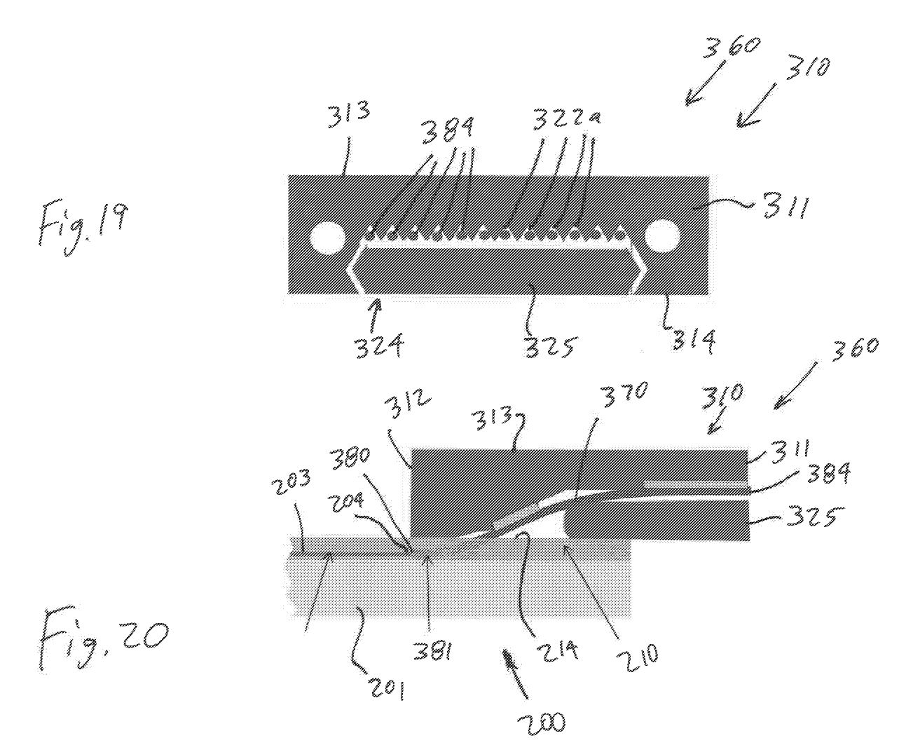

In still another embodiment depicted in FIGS. 18-20, a waveguide termination module 310 may be configured as a modified ferrule with a mating end or face 311, an opposite connection end 312, an upper surface 313, and a lower surface 314. The waveguide termination module 310 includes a fiber orientation and securement section 320 that extends from the mating face 311 towards the connection end 312 and a fiber termination section 330 that extends from the connection end towards the fiber orientation and securement section 320.

The fiber orientation and securement section 320 is operative to orient and secure the plurality of optical fibers 370 to the waveguide termination module 310 prior to terminating or connecting the termination module to the optical waveguide member 200. The fiber orientation and securement section 320 includes a first section 320a that extends from the mating face 311 towards the connection end 312 and a second section 320b that extends from the first section towards the connection end. The first section 320a includes a vertical recess 324 that extends from the lower surface 314 of the waveguide termination module 310. The upper surface 321a of the recess 324 is generally planar and may be generally, perpendicular to the mating face 311. The upper surface 321a of the recess 324 may include a first set of alignment members in the form of V-grooves 322a that extend from the mating face 311 towards the termination end 312 to facilitate securing the optical fibers 370 to the waveguide termination module 310. A cover or insert 325 may be inserted into the recess 324 after the optical fibers 370 are positioned within the V-grooves 322a.

The second section 320b includes an angled lower face 321b that extends downward from the upper surface 321a of the recess 324. The lower face 321b of second section 320b may include a second set of alignment members in the form of V-grooves 322.b to facilitate securing the optical fibers 370 to the waveguide termination module 310. In some embodiments, the second section 320b may not include the second set of alignment members and the optical fibers 370 may be secured within the first set of V-grooves 322a but oriented along second section 320b.

The fiber termination section 330 is operative to protect portions of the optical fibers 370 prior to mounting the waveguide termination module 310 on the optical waveguide member 200 to secure the termination module on the optical waveguide member, and may perform additional functions such as assisting in positioning portions of the optical fibers on the optical waveguide member as described above with respect to the waveguide termination module 10. The fiber termination section 330 may include a mounting surface 331 for mounting an optical waveguide termination module assembly 360 on an optical waveguide member 200 and a lower face (not shown) as described above with respect to the optical waveguide termination module assembly 60.

Each optical fiber 370 includes a first portion 378 that extends along the fiber orientation and securement section 320. A first fiber retention segment 387a of the first portion 378 may be secured within the first set of V-grooves 322a. An angled segment 388 of the first portion 378 extends along the lower face 321b of the second section 320b. The first portion 378 may thus include a second fiber retention segment 387b that is coextensive with a portion of the angled segment 388. In other words, the length of optical fiber that forms the second fiber retention segment 387b also forms a portion of the angled segment 388. In some embodiments, the second fiber retention segment 387b may be omitted.

Since the first portion 378 of the optical fibers 370 extends along the generally planar upper surface 3211.a and the angled lower face 321b, the first portion includes a curve or bend 390. As stated above, in some applications, it may be desirable to avoid a curve or bend in the optical fiber 370 that has a radius of less than approximately 0.25 inches. In other applications, it may be desirable to avoid a radius that is less than approximately 1.0 inch.

The optical fibers 370 also include a second portion 381 with a free end 380 that interacts with the fiber termination section 330 and the optical waveguide member 200 as described above with respect to the optical waveguide termination module assembly 60.

An optical waveguide termination module assembly 360 may be formed from the waveguide termination module 310 and optical fibers 370 in a manner similar to that described above with respect to the optical waveguide termination module assembly 160. The optical fibers 370 may have the buffer (not shown) and other materials surrounding the cladding 372 removed along the length thereof. A rough length of optical fibers 370 may be positioned along the lower surface 314 of the waveguide termination module 310 with the first fiber retention segment 387a secured within the first set of V-grooves 322a and the second fiber retention segment 387b secured within the second set of V-grooves 322b. The insert 325 may be secured within the recess 324. The optical fibers 370 may be cut or cleaved adjacent the mating face 311 to form the mating end 384 and adjacent the termination end 312 to form free end 380.

Comparing the optical waveguide termination module assembly 360 to the optical waveguide termination module assembly 60, it may be seen that the second section 320b of the fiber orientation and securement section 320 is similar to the fiber orientation and securement section 20 of assembly 60 and the fiber termination section 330 is similar to the fiber termination section 30 of assembly 60. While the assembly 360 includes a length of first portion 378 that extends along the generally planar upper surface 321a and that terminates at mating face 311, the optical fibers 70 of assembly 60 extend past the fiber end 11. In both assemblies 60, 360, the angled segment (78 in FIGS. 1-12 and 388 in FIGS. 18-20) are coextensive with a retention segment (78 in FIGS. 1-12 and 387b in FIGS. 18-20). However, as stated above, if the second set of V-grooves 322b were omitted from the second section 320b of fiber orientation and securement section 320, the fiber securement segment and the angled segment of the optical fibers 370 would be spaced apart.

Referring to FIG. 20, optical waveguide termination module assembly 360 may be mounted on optical waveguide member 200 as described above with respect to the optical waveguide termination module assembly 60.

It will be appreciated that the foregoing description provides examples of the disclosed system and technique. However, it is contemplated that other implementations of the disclosure may differ in detail from the foregoing examples. For example, although the embodiments are depicted with a plurality of optical fibers, the concepts described herein are applicable to embodiments including only a single optical fiber and a single, aligned waveguide. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. An optical waveguide termination module assembly comprising:
a waveguide termination module including an engagement surface for engaging one of an optical waveguide member and a surface of at least one optical fiber; and
at least one optical fiber secured to the waveguide termination module, each optical fiber having a first portion and a second portion, an angled segment of the first portion being at an angle to the engagement surface, and the second portion having a free end generally adjacent the engagement surface and being movable relative to the waveguide termination module prior to mounting the optical waveguide termination module assembly on the optical waveguide member.

2. The optical waveguide termination module assembly of claim 1, wherein the second portion extends from the first portion and the first and second portions are co-linear prior to mounting the optical waveguide termination module assembly on the optical waveguide member.

3. (canceled)

4. (canceled)

5. The optical waveguide termination module assembly of claim 1, wherein the waveguide termination module has a first section including a fiber retention section, the first portion of each optical fiber extends along the first section and a retention segment of the first portion is secured to the fiber retention section.

6. (canceled)

7. (canceled)

8. (canceled)

9. The optical waveguide termination module assembly of claim 1, wherein the engagement surface is a mounting surface for engaging the optical waveguide member.

10. The optical waveguide termination module assembly of claim 1, wherein the waveguide termination module has a second section including the mounting surface and a lower face adjacent the mounting surface, the second portion of each optical fiber extending generally along the lower face.

11. (canceled)

12. (canceled)

13. (canceled)

14. The optical waveguide termination module assembly of claim 1, wherein the first portion of each optical fiber has a retention segment, and the waveguide termination module has a first section and a second section, the first section includes a fiber retention section, the first portion of each optical fiber extends along the first section and the retention segment of the first portion of the optical fiber is secured to the fiber retention section, and the second section includes a mounting surface for engaging an optical waveguide member and a lower face adjacent the mounting surface, the second portion of each optical fiber extends generally along the lower face.

15. (canceled)

16. (canceled)

17. (canceled)

18. (canceled)

19. (canceled)

20. An optical assembly comprising:
an optical waveguide member including at least one waveguide with a waveguide free end, and an alignment channel generally parallel to and aligned with each waveguide;
a waveguide termination module; and
at least one optical fiber secured to the waveguide termination module, each optical fiber having a first portion and a second portion, the first portion including an angled segment, the second portion including a fiber free end aligned with the waveguide free end of one of the at least one waveguide, an alignment segment of the second portion being positioned within the alignment channel aligned with the one of at least one waveguide, the alignment segment of the second portion being at an angle to the angled segment of the first portion.

21. The optical assembly of claim 20, further including a mounting surface that engages the optical waveguide member.

22. The optical assembly of claim 21, wherein the first portion of each optical fiber has a retention segment, and
the waveguide termination module has a first section and a second section, the first section includes a fiber retention section, the first portion of each optical fiber extends along the first section and the retention segment of the first portion of each optical fiber is secured to the fiber retention section, and the second section includes the mounting surface and a lower face adjacent the mounting surface, the second portion of each optical fiber extends generally along the lower face.

23. (canceled)

24. (canceled)

25. (canceled)

26. (canceled)

27. (canceled)

28. (canceled)

29. (canceled)

30. A method of forming an optical assembly comprising:
providing an optical waveguide member including at least one waveguides, each waveguide having a waveguide free end, a waveguide axis, and an associated alignment channel generally parallel to and aligned with each waveguide;
providing a waveguide termination module assembly including at least one optical fiber secured thereto, each optical fiber having a first portion and a second portion, the second portion including a fiber free end;
positioning the waveguide termination module assembly relative to the optical waveguide member with the fiber free end of each optical fiber aligned with its associated alignment channel and with the second portion of each optical fiber at an angle to its associated waveguide axis;
moving the waveguide termination module assembly relative to the optical waveguide member to cause the fiber free end of each optical fiber to contact its aligned alignment channel;
further moving the waveguide termination module assembly relative to the optical waveguide member to deflect the second portion of each optical fiber and align the second portion with the waveguide axis of its aligned waveguide; and
securing the second portion of each optical fiber to the optical waveguide member to optically connect the fiber free end of each optical fiber to the waveguide free end of each aligned waveguide.

31. (canceled)

32. (canceled)

33. (canceled)

34. (canceled)

35. An optical waveguide termination module assembly comprising:
at least one optical fiber, each optical fiber having a first portion and a second portion, and the second portion having a free end; and
a waveguide termination module having a first section, the first portion of each optical fiber being secured to the first section, an alignment section, the second portion of each optical fiber extending in a cantilevered manner along the alignment section and away from the first section, and a waveguide support section having an opening therein configured to receive a portion of an optical waveguide member therein, the opening extending to the alignment section.

36. The optical waveguide termination module assembly of claim 35, further including a biasing member extending into at least one of the alignment section and the waveguide support section to bias the optical waveguide member upon inserting the optical waveguide member into the waveguide termination module.

37. The optical waveguide termination module assembly of claim 36, wherein a first portion of the biasing member is positioned within the alignment section and a second portion of the biasing member is positioned within the waveguide support section.

38. The optical waveguide termination module assembly of claim 35, wherein the first portion of each optical fiber has a mating end, the waveguide termination module is a ferrule having a mating face and the mating end of each optical fiber is positioned adjacent the mating face.

39. The optical waveguide termination module assembly of claim 35, wherein the waveguide termination module is a ferrule having a mating face, a mating end of each optical fiber being positioned adjacent the mating face of the ferrule, the mating end being positioned at an opposite end of each optical fiber from the free end.

40. An optical assembly comprising:
an optical waveguide member including at least one waveguide with a waveguide free end, and an alignment channel generally parallel to and aligned with each waveguide;
at least one optical fiber, each optical fiber having a first portion and a second portion, the second portion having a fiber free end aligned with the waveguide free end of one of the at least one waveguide, an alignment segment of each second portion being positioned within the alignment channel aligned with the one of the at least one waveguide; and
a waveguide termination module having a first section, an alignment section, and a waveguide support section, the first portion of each optical fiber being secured to the first section, the second portion of each optical fiber being secured within the alignment channel aligned with one of the at least one waveguide of the optical waveguide member along the alignment section, and the waveguide support section supporting a portion of the optical waveguide member.

41. The optical assembly of claim 40, further including a biasing member extending into at least one of the alignment section and the waveguide support section to bias the optical waveguide member upon inserting the optical waveguide member into the waveguide termination module, and wherein the fiber free end, the waveguide free end, the alignment section of the waveguide termination module, and the biasing member are secured together with an adhesive.

42. The optical assembly of claim 41, wherein the adhesive is an index-matched epoxy.

43. A method of forming an optical assembly comprising:
providing an optical waveguide member including at least one waveguide, each waveguide having a waveguide free end and a waveguide axis, and at least one alignment channel, each alignment channel being generally parallel to and aligned with one of the at least one waveguide;
providing a waveguide termination module including at least one optical fiber secured thereto, each optical fiber having a first portion and a second portion, the second portion including a fiber free end, the waveguide termination module having a first section with the first portion of each optical fiber secured thereto, and an alignment section with the second portion of each optical fiber extending in a cantilevered manner along and spaced from the alignment section and away from the first section;
positioning the waveguide termination module relative to the optical waveguide member with the fiber free end of each optical fiber aligned with and offset from one of the at least one alignment channel;
moving the optical waveguide member relative to the waveguide termination module to move the fiber free end of each optical fiber into its aligned alignment channel and align the second portion of each optical fiber with the waveguide axis of an aligned waveguide; and
securing the second portion of each optical fiber to the optical waveguide member to optically connect the fiber free end of each optical fiber to the waveguide free end of each aligned waveguide.

44. (canceled)

45. (canceled)

46. (canceled)

47. (canceled)

48. (canceled)
